(19) United States
(12) Patent Application Publication
(10) Pub. No.: US 2013/0036358 A1
(43) Pub. Date: Feb. 7, 2013

(54) NETWORK SYSTEM AND COMMUNICATION METHOD

(71) Applicants: Masahide Takasugi, Osaka-shi (JP); Toshio Akabane, Osaka-shi (JP)

(72) Inventors: Masahide Takasugi, Osaka-shi (JP); Toshio Akabane, Osaka-shi (JP)

(73) Assignee: SHARP KABUSHIKI KAISHA, Osaka-shi, Osaka (JP)

(21) Appl. No.: 13/637,610

(22) PCT Filed: Jul. 22, 2011
(86) PCT No.: PCT/JP2011/066728

§ 371 Date: Sep. 26, 2012

(30) Foreign Application Priority Data
Jul. 30, 2010 (JP) 2010-172155

(51) Int. Cl. G06F 3/041; G06F 3/048

(52) U.S. Cl. 715/733

(57) ABSTRACT

A first terminal (100A) receives a handwriting instruction and a pen type, and transmits the handwriting instruction and the pen type to a server (400). The server (400) refers to a memory to convert the handwriting instruction from the first terminal (100A) into drawing data used for displaying a handwriting image corresponding to the pen type from the first terminal (100A), and transmit the drawing data to the first terminal (100A). The first terminal (100A) displays the handwriting image corresponding to the pen type based on the drawing data from the server (400).

### TECHNICAL FIELD

The present invention relates to a network system including at least a first communication terminal and a server capable of communicating with each other via a network, and a communication method, and particularly to a network system having a first communication terminal and a server transmitting and receiving handwriting data to and from each other, and a communication method.

### BACKGROUND ART

There is a known network system in which a communication terminal connectable to an Internet network exchanges contents data with a server. There is also a known network system (server client system) in which a plurality of communication terminals connectable to an Internet network exchange contents data with one another via a server.

Furthermore, there is also a known network system in which a plurality of communication terminals connectable to an Internet network directly exchange contents data with one another, which may be, for example, a P2P (Peer to Peer) system, and the like.

In such network systems, communication terminals transmit and receive handwriting image data, text data, photographic data, and the like to and from each other. Then, each of the communication terminals causes a display to display a handwriting image, text and a photograph based on the received data.

For example, Japanese Patent National Publication No. 2006-511112 (PTL 1) discloses a mobile graphic display device. According to Japanese Patent National Publication No. 2006-511112 (PTL 1), the mobile graphic display device has a touch-panel display screen connected to a touch-panel processor. The touch-panel processor generates first ink data showing an input drawing operation performed on the touch-panel display screen. This device includes a graphic display and a graphic image processor displaying an image showing at least the first ink data on the graphic display screen in combination with the handwriting image that has been already produced. A wireless communication processor transmits the first ink data from the mobile graphic display device to another graphic display device and receives another ink data showing another drawing operation from another graphic display device. In accordance with the common reference, the graphic display processor generates a representation of another ink data for a representation of the first ink data. Consequently, the mobile graphic display device is configured to exchange the handwriting image with another device.

### CITATION LIST

Patent Literature

PTL 1: Japanese Patent National Publication No. 2006-511112

### SUMMARY OF INVENTION

### Technical Problem

However, in order to display the handwriting image drawn by a plurality of types of pens, it is necessary that at least one of the terminal receiving a handwriting instruction and the terminal displaying a handwriting image includes data used for converting (or changing) the handwriting instruction into a handwriting image (the data will be hereinafter also referred to as extension pen data) depending on the type of the pen used. Accordingly, companies operating the service could not easily add and update this extension pen data.

The present invention has been made to solve the above-described problems. An object of the present invention is to allow the communication terminal to receive a handwriting instruction corresponding to the pen type that is not adapted for the communication terminal itself and an instruction for selecting the pen type, and also allow the communication terminal to display a handwriting image corresponding to the pen type that is not adapted for the communication terminal itself.

### SOLUTION TO PROBLEM

According to an aspect of the present invention, a network system including a first terminal and a server is provided. The first terminal includes a first communication interface; a touch panel for receiving a handwriting instruction and a pen type; and a first processor for transmitting the handwriting instruction and the pen type to the server via the first communication interface and causing the touch panel to display a handwriting image corresponding to the pen type based on drawing data from the server. The server includes a server communication interface; a memory associating a rule for conversion from the handwriting instruction into the drawing data with the pen type and storing the rule and the pen type; and a server processor referring to the memory for converting the handwriting instruction from the first terminal into the drawing data used for displaying the handwriting image corresponding to the pen type from the first terminal and transmitting the drawing data to the first terminal via the server communication interface.

Preferably, the network system further includes a second terminal. The server processor transmits the drawing data also to the second terminal via the server communication interface. The second terminal includes a display, a second communication interface, and a second processor for causing the display to display the handwriting image corresponding to the pen type based on the drawing data from the server.

Preferably, the network system further includes a second terminal. The first processor transmits the drawing data to the second terminal via the first communication interface. The second terminal includes a display, a second communication interface, and a second processor for causing the display to display the handwriting image corresponding to the pen type based on the drawing data from the first terminal.

Preferably, the server processor transmits pen data showing a plurality of pen types adapted for the server to the first terminal via the server communication interface. The first processor causes the touch panel to display the plurality of pen types in a selectable manner based on the pen data.

Preferably, the first processor causes the touch panel to display a handwriting image corresponding to a prescribed pen type from a time when the handwriting instruction is received until a time when the handwriting image corresponding to the pen type is displayed.

According to another aspect of the present invention, a communication method in a network system including a first terminal and a server is provided. The server includes a memory for associating a rule for conversion from a handwriting instruction into drawing data with a pen type and storing the rule and the pen type. The communication method includes the steps of the first terminal receiving the handwriting instruction and the pen type; the first terminal transmitting the handwriting instruction and the pen type to the server; the server referring to the memory for converting the handwriting instruction from the first terminal into the drawing data used for displaying a handwriting image corresponding to the pen type from the first terminal; the server transmitting the drawing data to the first terminal; and the first terminal displaying the handwriting image corresponding to the pen type based on the drawing data from the server.

### ADVANTAGEOUS EFFECTS OF INVENTION

As described above, the network system and the communication method according to the present invention allow the communication terminal to receive a handwriting instruction corresponding to the pen type that is not adapted for the communication terminal itself and an instruction for selecting the pen type, and also allow the communication terminal to display a handwriting image corresponding to the pen type that is not adapted for the communication terminal itself.

### BRIEF DESCRIPTION OF DRAWINGS

FIG. 1 is a schematic diagram showing an example of a network system 1 according to the present embodiment.

FIG. 2 is a representation of the external appearance of a mobile phone 100 according to the present embodiment.

FIG. 3 is a block diagram showing the hardware configuration of mobile phone 100 according to the present embodiment.

FIG. 4 is a block diagram showing the hardware configuration of a chat server 400 according to the present embodiment.

FIG. 5 is a sequence diagram showing the outline of the operation in network system 1 according to the present embodiment.

FIG. 6 is a sequence diagram showing a process of transmitting and receiving a pen list in network system 1 according to the present embodiment.

FIG. 7 is a representation of the list of pen types displayed on a touch panel 102.

FIG. 8 is a sequence diagram showing a process of transmitting and receiving drawing data in a simple mode in network system 1 according to the present embodiment.

FIG. 9 is a representation of a touch operation (handwriting instruction).

FIG. 10 is a representation of input data 101A in the case where the first pen is selected.

FIG. 11 is a representation of drawing data 409A in the case where the first pen is selected.

FIG. 12 is a representation of the handwriting image in the case where the first pen is selected.

FIG. 13 is a representation of input data 101B in the case where the second pen is selected.

FIG. 14 is a representation of drawing data 409B in the case where the second pen is selected.

FIG. 15 is a representation of the handwriting image in the case where the second pen is selected.

FIG. 16 is a representation of input data 101C in the case where the third pen is selected.

FIG. 17 is a representation of drawing data 409C in the case where the third pen is selected.

FIG. 18 is a representation of the handwriting image in the case where the third pen is selected.

FIG. 19 is a representation of the manner of displaying the handwriting image in the simple mode according to the present embodiment.

FIG. 20 is a sequence diagram showing a process of transmitting and receiving drawing data in a detail mode in network system 1 according to the present embodiment.

FIG. 21 is a representation of the manner of displaying the handwriting image in the detail mode according to the present embodiment.

FIG. 22 is a flowchart illustrating a procedure of the handwriting chat process in mobile phone 100 according to the present embodiment.

FIG. 23 is a flowchart illustrating a procedure of the input process in mobile phone 100 according to the present embodiment.

FIG. 24 is a flowchart illustrating a procedure of the server reception process in mobile phone 100 according to the present embodiment.

FIG. 25 is an entire block diagram of network system 1 according to the present embodiment.

FIG. 26 is an entire block diagram of a modification of network system 1 according to the present embodiment.

FIG. 27 is a flowchart illustrating a procedure of the handwriting chat process in mobile phone 100 according to the present modification.

FIG. 28 is a flowchart illustrating a procedure of the server reception process in mobile phone 100 according to the present modification.

FIG. 29 is a flowchart illustrating a procedure of the terminal reception process in mobile phone 100 according to the present modification.

FIG. 30 is an entire block diagram of another server-client type network system.

FIG. 31 is an entire block diagram of another P2P-type network system.

### DESCRIPTION OF EMBODIMENTS

The embodiments of the present invention will be hereinafter described with reference to the accompanying drawings. In the following description, the same components are designated by the same reference characters. Names and functions thereof are also the same. Accordingly, the detailed description thereof will not be repeated.

Furthermore, a mobile phone 100 will be hereinafter referred to as a representative example of a “communication terminal”. However, the communication terminal may be a personal computer, a car navigation device (a satellite navigation system), a personal navigation device (PND), a personal data assistance (PDA) or other similar information communication devices.

<General Configuration of Network System 1>

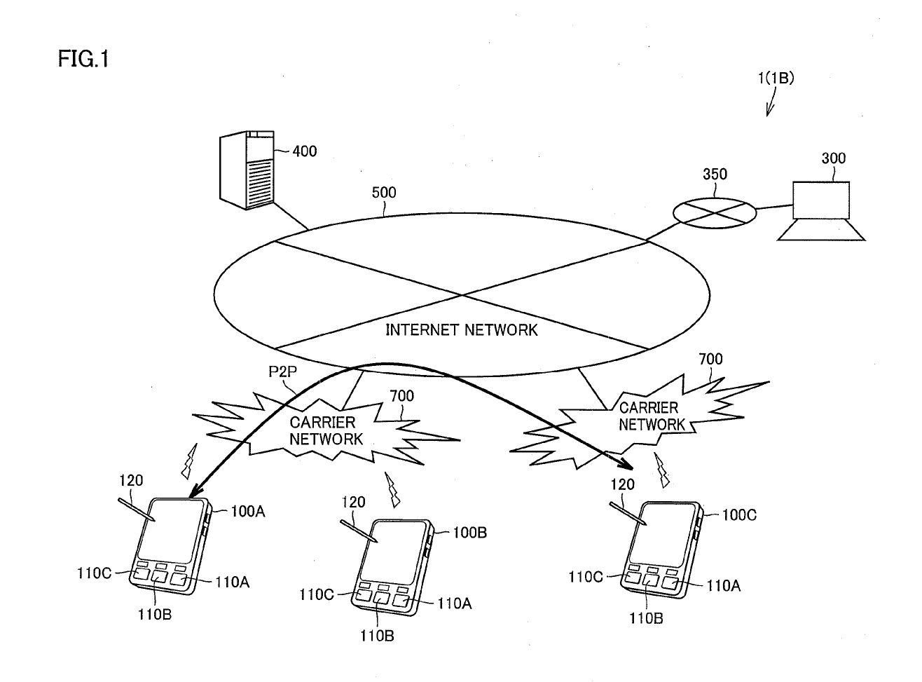

Initially, a network system 1 in the first embodiment will be described. FIG. 1 is a schematic diagram showing an example of network system 1 according to the present embodiment. As shown in FIG. 1, network system 1 includes mobile phones 100A, 100B and 100C, a chat server 400, an Internet network (first network) 500, and a carrier network (second network) 700. Network system 1 according to the present embodiment also includes a personal computer (PC) 300.

Note that, to facilitate description, hereinafter described will be network system 1 according to the present embodiment including first mobile phone 100A, second mobile phone 100B and third mobile phone 100C. Furthermore, in describing a configuration, a function or the like common to mobile phones 100A, 100B and 100C, the mobile phones will also collectively be referred to as mobile phone 100. Furthermore, in describing a configuration, a function or the like common to mobile phones 100A, 100B and 100C, and personal computer 300, they will also collectively be referred to as a communication terminal.

Mobile phone 100 is configured to be connectable to carrier network 700. Personal computer 300 is configured to be connectable through a local area network (LAN) 350, a wide area network (WAN) or the like to Internet network 500. Chat server 400 is configured to be connectable to Internet network 500.

More specifically, first mobile phone 100A, second mobile phone 100B, third mobile phone 100C, and personal computer 300 are interconnectable via carrier network 700, Internet network 500 and/or the like, and also capable of mutually transmitting and receiving data. Furthermore, mobile phone 100 and personal computer 300 are assigned identification information such as a mail address, an Internet protocol (IP) address or the like for identifying their own terminals.

In other words, mobile phone 100 and personal computer 300 can each store identification information of other communication terminals in its internal storage medium. Based on that identification information, mobile phone 100 and personal computer 300 can communicate data with these other communication terminals via carrier network 700, Internet network 500 and/or the like.

Note that mobile phone 100 and personal computer 300 according to the present embodiment use IP addresses assigned to other communication terminals to each communicate data with these other communication terminals without depending on servers. That is, network system 1 according to the present embodiment includes mobile phone 100 and personal computer 300 that are capable of configuring a so-called peer-to-peer (P2P) type network. It is not indispensable that mobile phones 100 communicate with each other via P2P communication.

Herein, when each communication terminal accesses chat server 400, that is, when each communication terminal accesses the Internet, the communication terminal is assigned an IP address by chat server 400 or another server device (not shown). The IP address is assigned in a process known in detail, and accordingly, how the IP address is assigned will not be described in detail.

As described later, in the present embodiment, chat server 400 is configured to generate drawing data based on the handwriting instruction. Note that network system 1 may have a server for handwriting communication that is used for generating drawing data from the handwriting instruction, separately from chat server 400.

<Hardware Configuration of Mobile Phone 100>

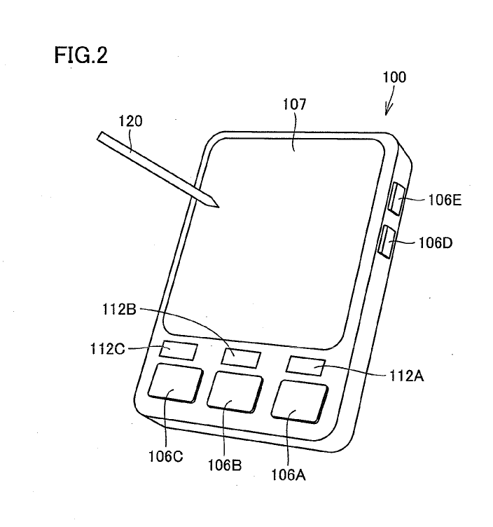

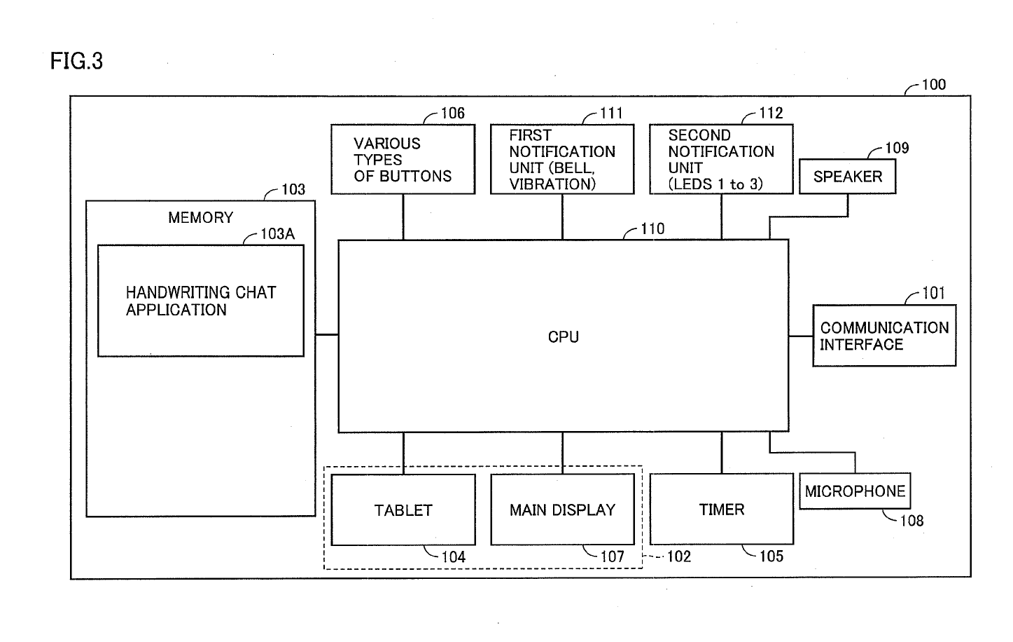

Mobile phone 100 according to the present embodiment has a hardware configuration, as will be described hereinafter. FIG. 2 is a representation of the external appearance of mobile phone 100 according to the present embodiment. FIG. 3 is a block diagram showing the hardware configuration of mobile phone 100 according to the present embodiment.

As shown in FIGS. 2 and 3, mobile phone 100 according to the present embodiment includes a communication interface 101 communicating data with an external network, a memory 103 storing a program and a variety of types of databases, a CPU (Central Processing Unit) 110, a display 107, a microphone 108 receiving external sound, a speaker 109 outputting sound, various types of buttons 106 receiving a various pieces of information input, a first notification unit 111 outputting audible notification indicating that externally communicated data, a call signal and/or the like have/has been received, and a second notification unit 112 displaying notification indicating that externally communicated data, a call signal and/or the like have/has been received.

Display 107 according to the present embodiment implements a touch panel 102 configured of a liquid crystal panel, a CRT or the like. Specifically, mobile phone 100 according to the present embodiment is provided with a pen tablet 104 under (or at the back side of) display 107. This allows a user to use a stylus pen 120 or the like to handwrite and input graphical information or the like through pen tablet 104 to CPU 110. Display 107 (touch panel 102) displays an image, a text and/or the like based on data output by CPU 110.

Various types of buttons 106 receive information from the user, for example, by operating a key for input. For example, various types of buttons 106 include a TEL button 106A for receiving a telephone call or making a telephone call, a mail button 106B for receiving mail or sending mail, a P2P button 106C for receiving P2P communication or sending P2P communication, an address book button 106D used to access address book data, and an end button 106E for terminating a variety of types of processes. That is, when P2P participation request mail is received via communication interface 101, various types of buttons 106 selectably receive an instruction input by the user to enter a chat room, an instruction to display the mail's content(s), and the like.

First notification unit 111 outputs a ringer tone through speaker 109 or the like. Alternatively, first notification unit 111 has a vibration function. When an incoming call, mail, P2P participation request mail and/or the like are/is received, first notification unit 111 outputs sound, vibrates mobile phone 100, and/or the like.

Second notification unit 112 includes a light emitting diode (LED) 112A for TEL, an LED 112B for mail, and an LED 112C for P2P. LED 112A for TEL flashes on/off when a call is received. LED 112B for mail flashes on/off when mail is received. LED 112C for P2P flashes on/off when P2P communication is received.

CPU 110 controls each unit of mobile phone 100. For example, CPU 110 receives a variety of types of instructions from the user via various types of buttons 106, and communicates data with an external communication terminal and chat server 400 via communication interface 101, a network and/or the like.

Communication interface 101 receives data to be communicated from CPU 110, converts the data into a communication signal, and sends the signal through an antenna (not shown). Communication interface 101 converts the communication signal received through the antenna into communication data and inputs the communication data into CPU 110.

Memory 103 is implemented as: random access memory (RAM) functioning as working memory; read only memory (ROM) storing a control program or the like; a hard disk storing image data or the like; and the like. Memory 103 according to the present embodiment stores a handwriting chat application 103A for performing the communication process described later.

When CPU 110 executes handwriting chat application 103A, mobile phone 100 according to the present embodiment can conduct a handwriting chat with another communication terminal via chat server 400.

<Hardware Configuration of Chat Server 400>

Then, the hardware configuration of chat server 400 according to the present embodiment will be described. The hardware configuration of chat server 400 will be hereinafter first described.

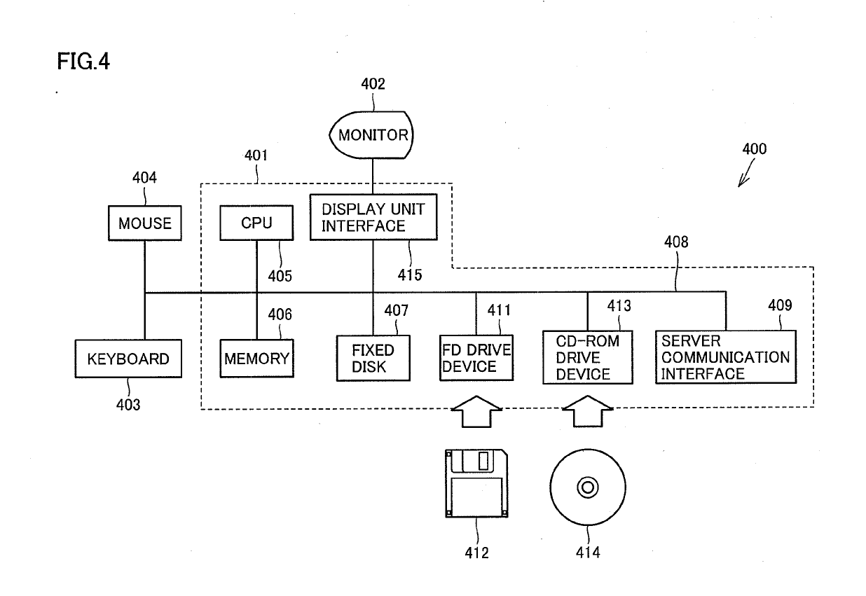

FIG. 4 is a block diagram showing the hardware configuration of chat server 400 according to the present embodiment. As shown in FIG. 4, chat server 400 according to the present embodiment includes a CPU 405, a memory 406, a fixed disk 407, and a server communication interface 409 interconnected by an internal bus 408.

Memory 406 stores a variety of types of information, and for example, temporarily stores data required for executing a program in CPU 405. Fixed disk 407 stores a program executed by CPU 405, a database, and the like. CPU 405, which controls each element of chat server 400, is a device performing a variety of types of operations.

More specifically, in the present embodiment, memory 406 or fixed disk 407 of chat server 400 stores extension pen data. The extension pen data is stored in such a manner that several types of methods for conversion from the stroke information described later into drawing data are associated with their respective pen types (pen ID). This allows CPU 405 to convert the stroke information (included in the input data described later) from mobile phone 100 into drawing data in accordance with the pen type.

Server communication interface 409 receives data output from CPU 405, converts the data into an electrical signal, and externally transmits the signal. Server communication interface 409 also converts the externally received electrical signal into data and inputs the data to CPU 405. More specifically, server communication interface 409 receives data from CPU 405 and transmits the data on Internet network 500, carrier network 700, and/or the like to mobile phone 100, personal computer 300 and/or the like. Server communication interface 409 also receives data via Internet network 500, carrier network 700 and/or the like from mobile phone 100, personal computer 300 and/or the like and inputs the data to CPU 405.

<General Outline of Operation of Network System 1>

Network system 1 according to the present embodiment generally operates, as will be described hereinafter. FIG. 5 is a sequence diagram showing an outline of the operation in network system 1 according to the present embodiment. As shown in FIGS. 1 and 5, the communication terminals according to the present embodiment first need to exchange (or obtain) their IP addresses mutually in order to perform P2P-type data communication. Once each communication terminal has obtained an IP address, the communication terminal performs P2P-type data communication to transmit a message, an attached file, and/or the like to other communication terminals. As described above, it is not indispensable that mobile phones 100 communicate with each other via P2P communication.

Hereinafter described will be the case where each of communication terminals transmits and receives a message and an IP address via a chat room generated in chat server 400, and performs P2P communication based on each other's IP address.

Initially, first mobile phone 100A (indicated as a terminal A in FIG. 5) requests IP registration (or login) from chat server 400 (step S002). First mobile phone 100A may obtain an IP address simultaneously, or may obtain it in advance from another server device or the like. More specifically, via carrier network 700 and Internet network 500, first mobile phone 100A transmits to chat server 400 the mail and IP addresses of first mobile phone 100A, the mail address of second mobile phone 100B (a terminal B in FIG. 5), and a request to generate a new chat room.

In response to the request, chat server 400 associates the mail address of first mobile phone 100A with the IP address thereof and thus stores the addresses. Chat server 400 generates a room name based on the mail address of first mobile phone 100A and the mail address of second mobile phone 100B, or extracts the room name included in the message, and then, generates a chat room with that room name. Chat server 400 may notify first mobile phone 100A that the chat room has been generated. Chat server 400 associates the room name with the current participant communication terminals' IP addresses and thus stores them.

The user of first mobile phone 100A informs the user of second mobile phone 100B that a new chat room has been generated, that is, invites the user of second mobile phone 100B to the chat room. For example, first mobile phone 100A transmits the P2P participation request mail to second mobile phone 100B via carrier network 700 and Internet network 500.

When second mobile phone 100B receives the P2P participation request mail, second mobile phone 100B generates a room name based on the mail address of first mobile phone 100A and the mail address of second mobile phone 100B or obtains the room name from the participation request mail, and then, transmits to chat server 400 the mail and IP addresses of second mobile phone 100B and a message indicating that second mobile phone 100B will enter the chat room having the room name (step S008). Second mobile phone 100B may obtain an IP address simultaneously, or may initially obtain an IP address and subsequently access chat server 400. In this case, chat server 400 may delete the chat room.

Chat server 400 receives the message and associates the mail address of second mobile phone 100A with the IP address thereof and stores them. Then, chat server 400 signals to first mobile phone 100A that second mobile phone 100B has entered the chat room, and chat server 400 transmits the IP address of second mobile phone 100B to first mobile phone 100A (step S010). Simultaneously, chat server 400 signals to second mobile phone 100B that chat server 400 has accepted entrance of second mobile phone 100B into the chat room, and chat server 400 transmits the IP address of first mobile phone 100A to second mobile phone 100B.

First mobile phone 100A transmits a P2P connection request message (a starting message) to second mobile phone 100B, based on the IP address of second mobile phone 100B (step S012). Second mobile phone 100B receives the connection request message, and transmits a first connection acceptance message (an answer message) to first mobile phone 100A, based on the IP address of first mobile phone 100A (step S014). First mobile phone 100A receives the first connection acceptance message from second mobile phone 100B, and transmits a second connection acceptance message to second mobile phone 100B (step S016).

Thus, first mobile phone 100A and second mobile phone 100B authenticate each other. Upon completion of the authentication, first mobile phone 100A and second mobile phone 100B start P2P handwriting chat communication (step S018). The P2P handwriting chat communication will be described later.

Then, when first mobile phone 100A transmits to second mobile phone 100B a disconnection request message indicating that P2P communication is severed (step S030), second mobile phone 100B transmits to first mobile phone 100A a disconnection acceptance message indicating that second mobile phone 100B has accepted the request to sever the communication (step S032).

<P2P Handwriting Chat Communication>

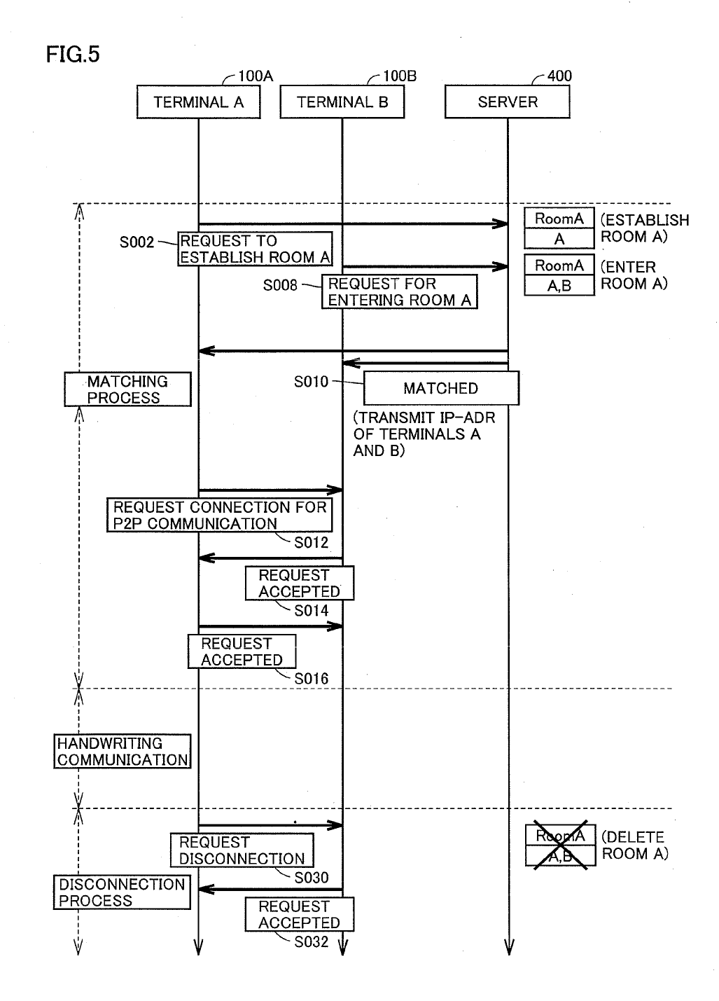

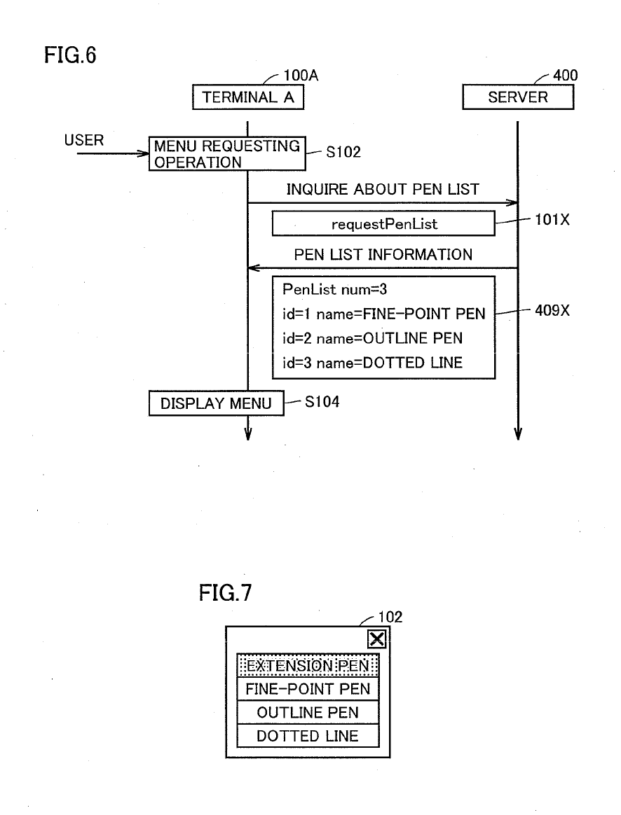

The operation for P2P handwriting chat communication in network system 1 according to the present embodiment will be hereinafter described. First, a description will be given with regard to transmission and reception of the pen list in network system 1 according to the present embodiment. FIG. 6 is a sequence diagram showing a process of transmitting and receiving the pen list in network system 1 according to the present embodiment.

As shown in FIG. 6, when P2P handwriting chat communication is started, mobile phone 100 inquires of chat server 400 about the pen list (step S102). More specifically, in response to the instruction from the user via touch panel 102 or automatically, CPU 110 of mobile phone 100 transmits a “requestPenList” message 101 X to chat server 400 via communication interface 101.

In response to the inquiry from mobile phone 100, CPU 405 of chat server 400 transmits pen list information 409X to mobile phone 100 via communication interface 409. Pen list information 409X includes a pen ID and text data showing pen's characteristics that are associated with each other for each pen type.

FIG. 7 is a representation of the list of pen types displayed on touch panel 102. Referring to FIG. 7, CPU 110 of mobile phone 100 causes touch panel 102 to display the list showing pen types based on pen list information 409X from chat server 400. In pen list information 409X, text data “fine-point pen”, text data “outline pen” producing a line outlined in fine lines in different color and text data “dotted line” are associated with pen ID “1”, pen ID “2” and pen ID “3”, respectively.

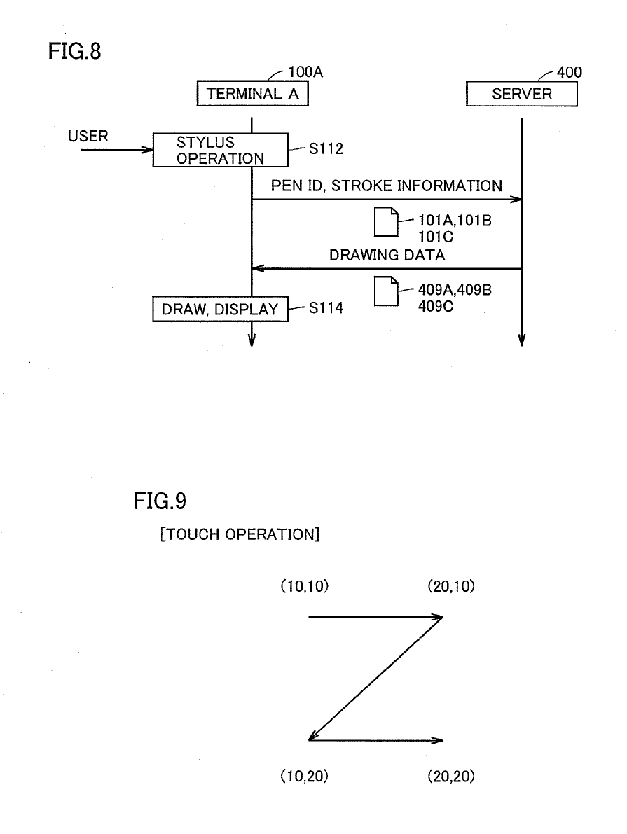

Then, a description will be given with regard to the process of transmitting and receiving the drawing data in a simple mode in network system 1 according to the present embodiment. FIG. 8 is a sequence diagram showing a process of transmitting and receiving the drawing data in the simple mode in network system 1 according to the present embodiment.

As shown in FIG. 8, upon completion of the process of transmitting and receiving the pen list, mobile phone 100 receives the handwriting instruction from the user (step S 112). In other words, CPU 110 of mobile phone 100 receives a touch operation performed by the user on touch panel 102. In the present embodiment, CPU 110 receives, via touch panel 102, the touch operation (a selection instruction) for selecting a pen type and the touch operation (a handwriting instruction) for drawing a handwriting stroke on touch panel 102.

FIG. 9 is a representation of the touch operation (handwriting instruction). Referring to FIG. 9, in the present embodiment, a description will be given with regard to the case where the user enters a character “Z” on touch panel 102 using a stylus pen 120 or the like. CPU 110 detects via touch panel 102 that an external object has touched the position at coordinates (10, 10), the object has slid from coordinates (10, 10) to coordinates (20, 10), the object has slid from coordinates (20, 10) to coordinates (10, 20), the object has slid from coordinates (10, 20) to coordinates (20, 20), and the object has been separated away from the position at touch coordinates (20, 20).

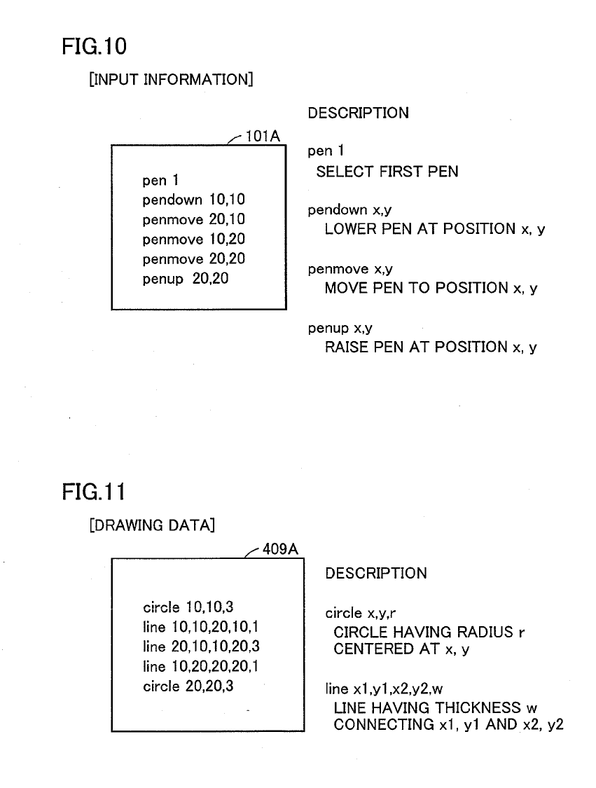

Hereinafter described will be the case where the user selects the first pen as a pen type. FIG. 10 is a representation of input data 101A in the case where the first pen is selected. As shown in FIGS. 8 to 10, based on the touch operation, CPU 110 generates input data 101A including a pen ID for designating a pen type and stroke information showing a handwriting instruction. The stroke information is draw data, based on which a plurality of types of mobile phones 100 (at least terminal A and terminal B) each can display an image.

CPU 110 transmits input data 101 A to chat server 400 via communication interface 101. CPU 405 of chat server 400 refers to memory 406 to generate drawing data 409A based on input data 101A. Drawing data 409A is draw data or paint data, based on which a plurality of types of mobile phones 100 each can display an image.

FIG. 11 is a representation of drawing data 409A in the case where the first pen is selected. Referring to FIGS. 8 to 11, CPU 405 converts the stroke information into drawing data 409A based on the pen ID. CPU 405 transmits drawing data 409A to mobile phone 100.

CPU 110 of mobile phone 100 receives drawing data 409A via communication interface 101. Based on drawing data 409A, CPU 110 causes touch panel 102 to display the handwriting image drawn by the selected pen.

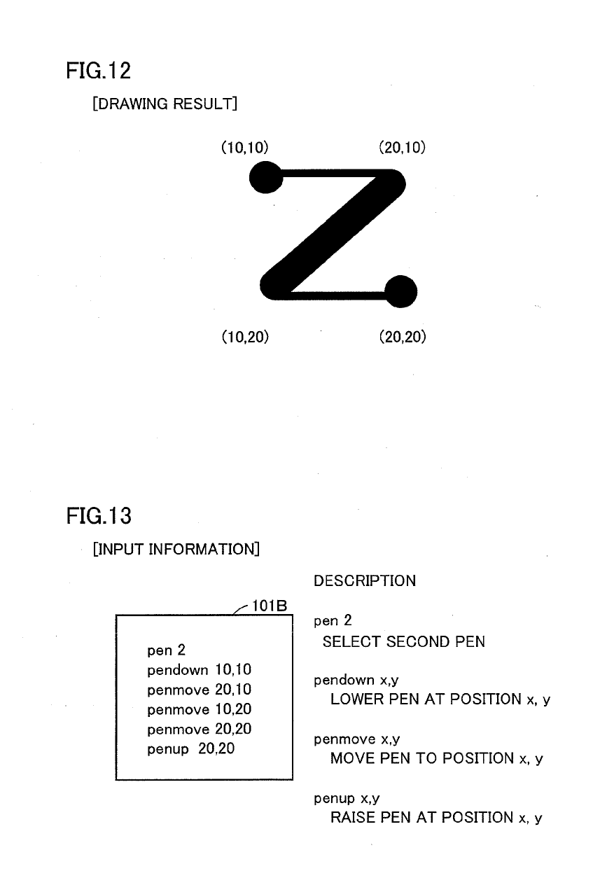

FIG. 12 is a representation of the handwriting image in the case where the first pen is selected. Referring to FIG. 12, CPU 110 causes touch panel 102 to display a handwriting image (handwriting character) in such a style that a line width is increased in a horizontal direction.

Then, a description will be given with regard to the case where the user selects the second pen as a pen type. FIG. 13 is a representation of input data 101B in the case where the second pen is selected. As shown in FIGS. 8, 9 and 13, based on the touch operation, CPU 110 produces input data 101B including a pen ID for designating the pen type and stroke information showing a touch operation (handwriting instruction).

CPU 110 transmits input data 101 B to chat server 400 via communication interface 101. CPU 405 of chat server 400 refers to memory 406 to generate drawing data 409B based on input data 101B. Drawing data 409B is draw data or paint data, based on which a plurality of types of mobile phones 100 each can display an image.

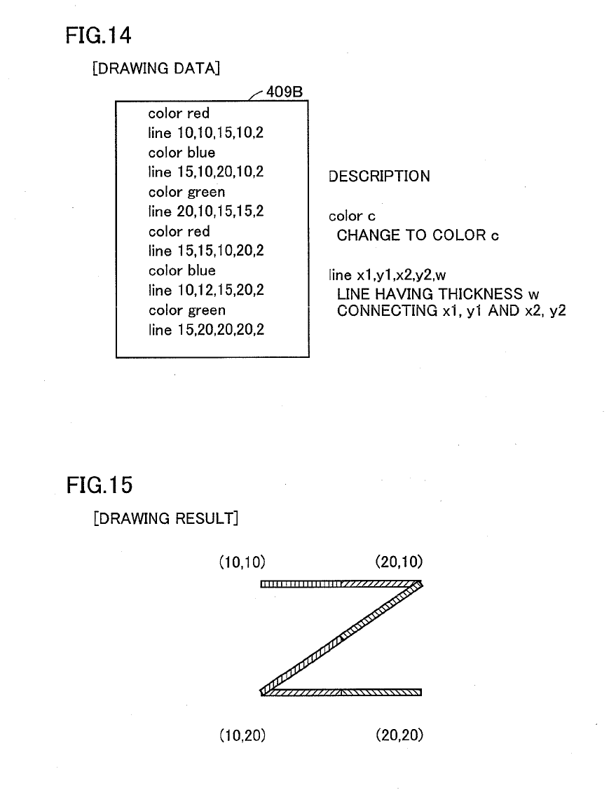

FIG. 14 is a representation of drawing data 409B in the case where the second pen is selected. Referring to FIGS. 8, 9, 13, and 14, CPU 405 converts the stroke information into drawing data 409B based on the pen ID. CPU 405 transmits drawing data 409B to mobile phone 100.

CPU 110 of mobile phone 100 receives drawing data 409B via communication interface 101. Based on drawing data 409B, CPU 110 causes touch panel 102 to display the handwriting image drawn by the selected pen.

FIG. 15 is a representation of the handwriting image in the case where the second pen is selected. Referring to FIG. 15, CPU 110 causes touch panel 102 to display the handwriting image (handwriting character) drawn in seven colors.

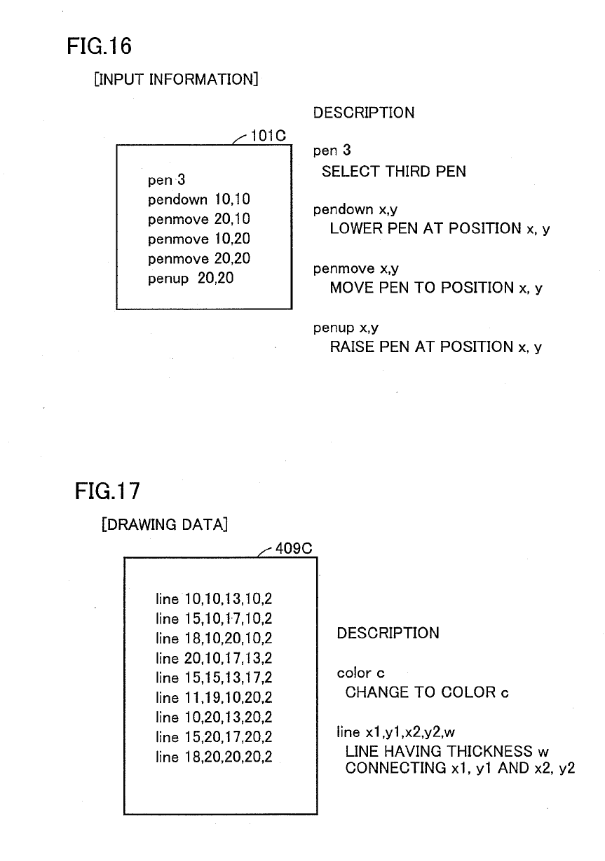

Then, a description will be given with regard to the case where the user selects the third pen as a pen type. FIG. 16 is a representation of input data 101C in the case where the third pen is selected. As shown in FIGS. 8, 9 and 16, based on the touch operation, CPU 110 produces input data 101C including a pen ID for designating the pen type and stroke information showing the touch operation (handwriting instruction).

CPU 110 transmits input data 101C to chat server 400 via communication interface 101. CPU 405 of chat server 400 refers to memory 406 to generate drawing data 409C based on input data 101C. Drawing data 409C is draw data or paint data, based on which a plurality of types of mobile phones 100 each can display an image.

FIG. 17 is a representation of drawing data 409C in the case where the third pen is selected. Referring to FIGS. 8, 9, 16, and 17, CPU 405 converts the stroke information into drawing data 409C based on the pen ID. CPU 405 transmits drawing data 409C to mobile phone 100.

CPU 110 of mobile phone 100 receives drawing data 409C via communication interface 101. Based on drawing data 409C, CPU 110 causes touch panel 102 to display the handwriting image drawn by the selected pen.

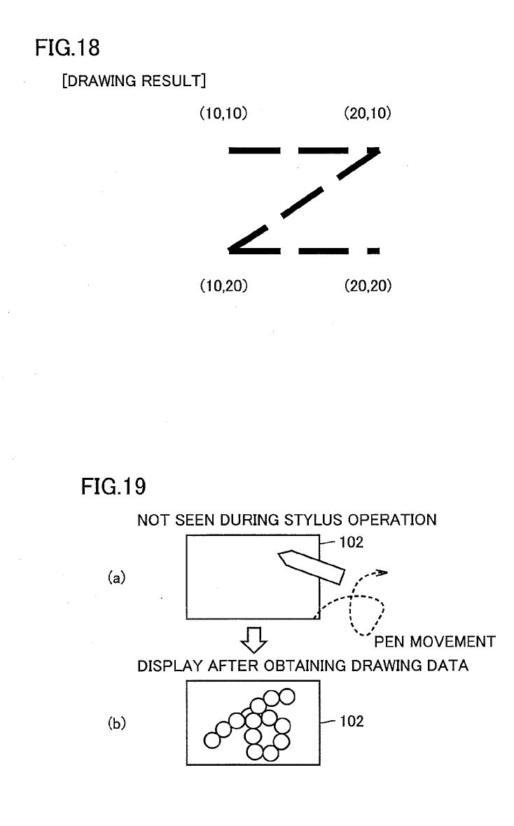

FIG. 18 is a representation of the handwriting image in the case where the third pen is selected. Referring to FIG. 18, CPU 110 causes touch panel 102 to display the handwriting image (handwriting character) drawn by a dotted line.

In this way, in the present embodiment, mobile phone 100 produces draw data (handwriting instruction) by which a plurality of types of mobile phones 100 each can display an image based on the touch operation. Mobile phone 100 transmits, to chat server 400, input data 101A, 101B and 101C each including draw data and a pen ID corresponding to the input instruction for selecting a pen. Chat server 400 converts the draw data into drawing data based on the pen ID. Mobile phone 100 displays the drawing data.

FIG. 19 is a representation of the manner of displaying the handwriting image in the simple mode according to the present embodiment. Referring to FIGS. 8 and 19, in the simple mode, CPU 110 receives the drawing data, and then, causes touch panel 102 to display the handwriting image in accordance with the pen type. In other words, even if CPU 110 receives a handwriting instruction, CPU 110 does not causes a corresponding handwriting image to be displayed until it receives the drawing data from chat server 400.

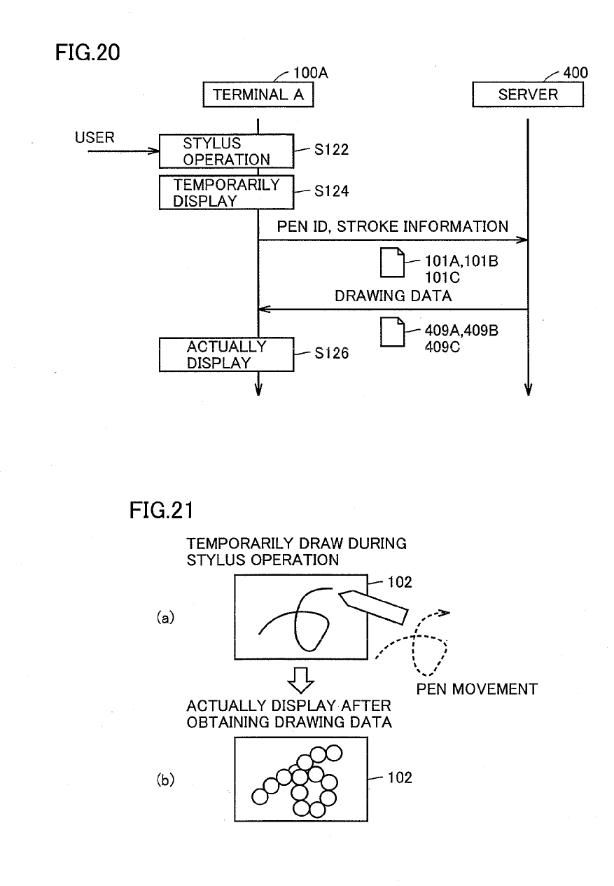

Then, a description will be given with regard to the process of transmitting and receiving drawing data in the detail mode in network system 1 according to the present embodiment. FIG. 20 is a sequence diagram showing a process of transmitting and receiving drawing data in the detail mode in network system 1 according to the present embodiment. FIG. 21 is a representation of the manner of displaying the handwriting image in the detail mode according to the present embodiment. In addition, since input data 101A, 101B and 101C and drawing data 409A, 409B and 409C are transmitted and received in the detail mode in a similar manner to the case in the simple mode, description thereof will not be repeated.

Referring to FIGS. 20 and 21, CPU 110 receives a handwriting instruction in the detail mode (step S122). CPU 110 causes touch panel 102 to display a handwriting image drawn by a default pen (in the line type or character style that can be displayed on mobile phone 100) (step S124). CPU 110 transmits input data 101A, 101B and 101C via communication interface 101. CPU 110 receives drawing data 409A, 409B and 409C. CPU 110 causes touch panel 102 to display a handwriting image in accordance with the pen type. In other words, when receiving the drawing data from chat server 400, CPU 110 redraws the handwriting image.

In the present embodiment, CPU 110 of mobile phone 100 receives, via touch panel 102, an instruction for switching between the simple mode and the detail mode.

<Handwriting Chat Process in Mobile Phone 100>

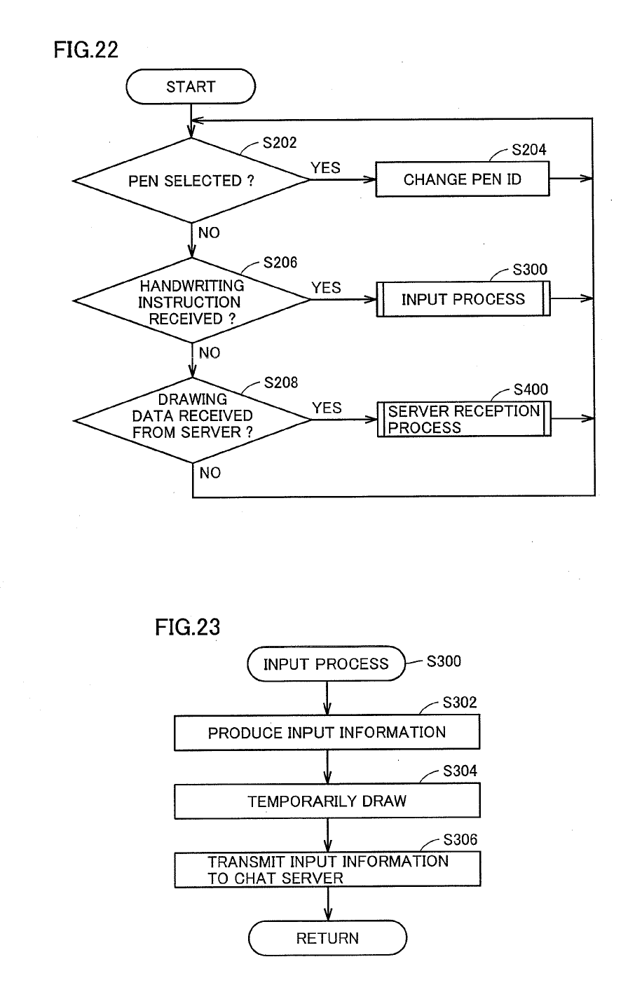

In the present embodiment, mobile phone 100 performs the handwriting chat process, as will be described hereinafter. FIG. 22 is a flowchart illustrating a procedure of the handwriting chat process in mobile phone 100 according to the present embodiment.

Referring to FIG. 22, CPU 110 determines whether or not it has received the instruction for selecting a pen from the user via touch panel 102 (step S202). When having received the instruction for selecting a pen from the user (YES in step S202), CPU 110 changes the pen ID (step S204). CPU 110 then repeats the process from step S202.

When having not received the instruction for selecting a pen from the user (NO in step S202), CPU 110 determines whether or not it has received the handwriting instruction (stroke operation) from the user via touch panel 102 (step S206). When having received the handwriting instruction (stroke operation) from the user (YES in step S206), CPU 110 performs an input process (step S300). The input process (step S300) will be described later. CPU 110 repeats the process from step 5202.

When having not received the handwriting instruction (stroke operation) from the user (NO in step S206), CPU 110 determines whether or not it has received the drawing data from chat server 400 (step S208). When having received the drawing data from chat server 400 (YES in step S208), CPU 110 performs a server reception process (step S400). The server reception process (step S400) will be described later. CPU 110 repeats the process from step 5202.

CPU 110 repeats the process from step 5202 also when it has not received the drawing data from chat server 400 (NO in step S208).

In the present embodiment, mobile phone 100 performs the input process, as will be described hereinafter. FIG. 23 is a flowchart illustrating a procedure of the input process in mobile phone 100 according to the present embodiment.

Referring to FIG. 23, CPU 110 produces stroke information via touch panel 102. CPU 110 produces input information from the stroke information and the pen ID (step S302). Based on the stroke information, CPU 110 causes a handwriting image to be temporarily drawn on touch panel 102 using a prescribed pen type (in a default line type) (step S304). CPU 110 then transmits the input information to chat server 400 via communication interface 101 (step S306). CPU 110 returns to the handwriting chat process.

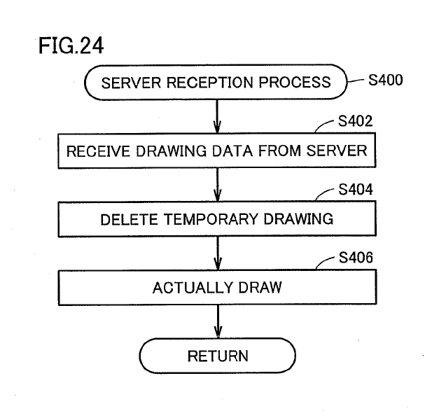

In the present embodiment, mobile phone 100 performs the server reception process, as will be described hereinafter. FIG. 24 is a flowchart illustrating a procedure of the server reception process in mobile phone 100 according to the present embodiment.

Referring to FIG. 24, CPU 110 receives drawing data from chat server 400 via communication interface 101 (step S402). CPU 110 causes the handwriting image temporarily drawn on touch panel 102 to be deleted (step S404). CPU 110 causes a handwriting image to be drawn on touch panel 102 based on the drawing data (step S406). CPU 110 returns to the handwriting chat process.

<Summary of Network System 1 according to Present Embodiment>

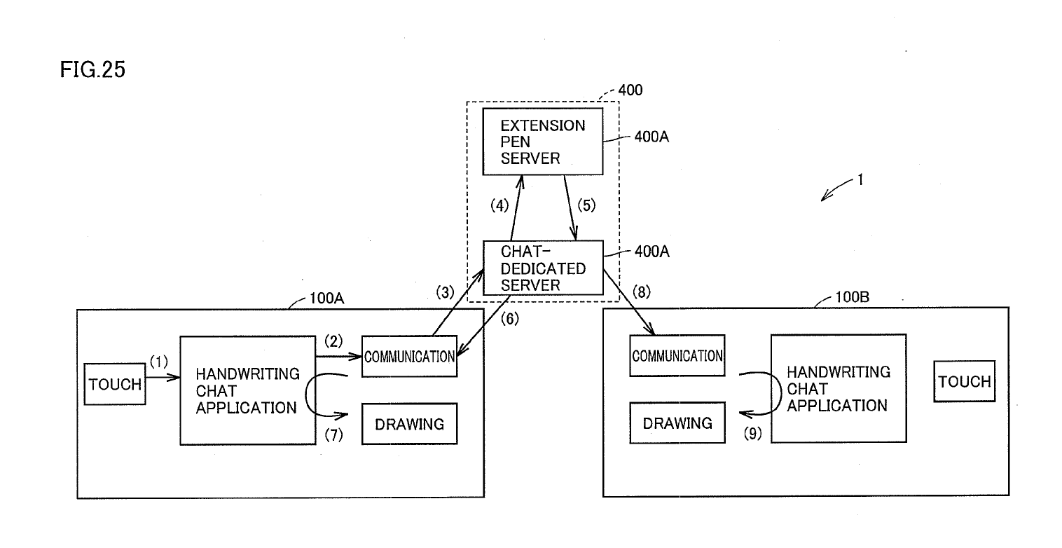

Network system 1 according to the present embodiment will be summarized as follows. FIG. 25 is an entire block diagram of network system 1 according to the present embodiment.

Referring to FIG. 25, the user first inputs a handwriting instruction and a pen type into first mobile phone 100A via touch panel 102 (1). The handwriting chat application of first mobile phone 100A delivers the handwriting instruction and the pen type to communication interface 101 (2). Communication interface 101 transmits the handwriting instruction and the pen type to chat server 400 (3).

Chat server 400 converts the handwriting instruction into drawing data in accordance with the pen type. Chat server 400 transmits the drawing data to first mobile phone 100A (6). First mobile phone 100A causes display 107 to display the handwriting image in accordance with the pen type based on the drawing data (7). Similarly, chat server 400 transmits the drawing data to second mobile phone 100B (8). Second mobile phone 100B causes display 107 to display the handwriting image in accordance with the pen type based on the drawing data (9).

Note that chat server 400 may include a chat-dedicated server 400A and an extension pen server 400B. In this case, the user inputs a handwriting instruction and a pen type into first mobile phone 100A via touch panel 102 (1). The handwriting chat application of first mobile phone 100A delivers the handwriting instruction and the pen type to communication interface 101 (2). Communication interface 101 transmits the handwriting instruction and the pen type to chat-dedicated server 400A (3).

Chat-dedicated server 400A transmits the handwriting instruction and the pen type to extension pen server 400B (4). Extension pen server 4008 converts the handwriting instruction into drawing data in accordance with the pen type. Extension pen server 400B transmits the drawing data to chat-dedicated server 400A (5).

Chat-dedicated server 400A transmits the drawing data to first mobile phone 100A (6). First mobile phone 100A causes display 107 to display the handwriting image in accordance with the pen type based on the drawing data (7). Similarly, chat-dedicated server 400A transmits the drawing data to second mobile phone 100B (8). Second mobile phone 100B causes display 107 to display the handwriting image in accordance with the pen type based on the drawing data (9).

<Modification of Network System 1>

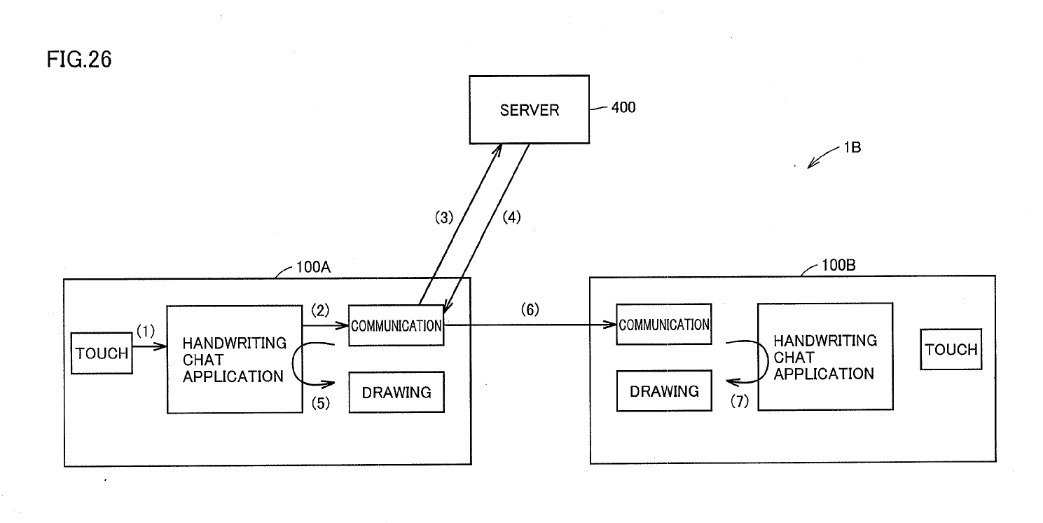

As shown in FIG. 25, network system 1 according to the present embodiment is configured such that chat server 400 converts the stroke information from mobile phone 100A into drawing data and transmits this drawing data to mobile phone 100A and another mobile phone 100B under chat communication with this mobile phone 100A, but may also be configured such that mobile phone 100A transfers the drawing data from chat server 400 to another mobile phone 100B under communication with this mobile phone 100A. FIG. 26 is an entire block diagram of a modification of network system 1 according to the present embodiment.

Referring to FIG. 26, the user first inputs a handwriting instruction and a pen type into first mobile phone 100A via touch panel 102 (1). The handwriting chat application of first mobile phone 100A delivers the handwriting instruction and the pen type to communication interface 101 (2). Communication interface 101 transmits the handwriting instruction and the pen type to chat server 400 (3).

Chat server 400 converts the handwriting instruction into drawing data in accordance with the pen type. Chat server 400 transmits the drawing data to first mobile phone 100A (4). First mobile phone 100A causes display 107 to display the handwriting image in accordance with the pen type based on the drawing data (5).

First mobile phone 100A transmits the drawing data to second mobile phone 100B (6). Second mobile phone 100B causes display 107 to display the handwriting image in accordance with the pen type based on the drawing data (7). Note that chat server 400 may include chat-dedicated server 400A and extension pen server 400B. In this case, the user inputs a handwriting instruction and a pen type into first mobile phone 100A via touch panel 102 (1). The handwriting chat application of first mobile phone 100A delivers the handwriting instruction and the pen type to communication interface 101 (2). Communication interface 101 transmits the handwriting instruction and the pen type to chat-dedicated server 400A (3).

Chat-dedicated server 400A transmits the handwriting instruction and the pen type to extension pen server 400B. Extension pen server 400B converts the handwriting instruction into drawing data in accordance with the pen type. Extension pen server 400B transmits the drawing data to chat-dedicated server 400A.

Chat-dedicated server 400A transmits the drawing data to first mobile phone 100A (4). First mobile phone 100A causes display 107 to display the handwriting image in accordance with the pen type based on the drawing data (5). First mobile phone 100A transmits the drawing data to second mobile phone 100B (6). Second mobile phone 100B causes display 107 to display the handwriting image in accordance with the pen type based on the drawing data (7).

<Handwriting Chat Process in Mobile Phone 100>

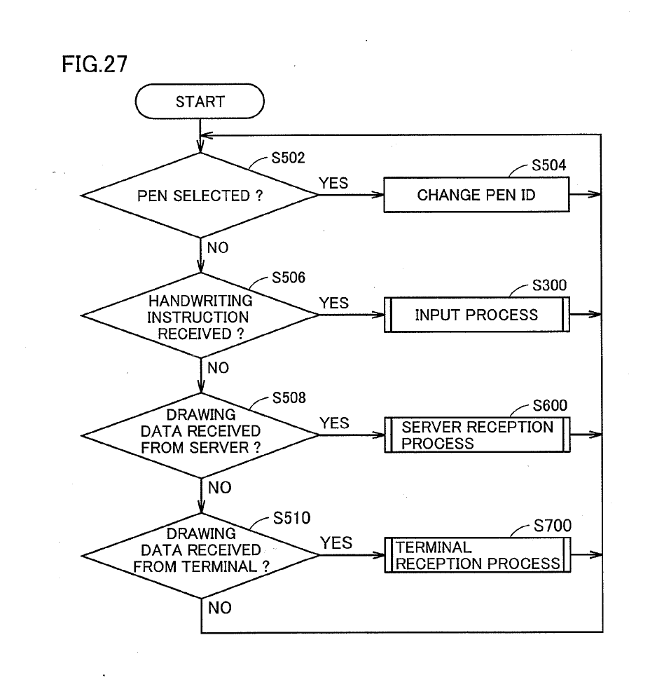

Then, the handwriting chat process in the present modification will be described. FIG. 27 is a flowchart illustrating a procedure of the handwriting chat process in mobile phone 100 according to the present modification.

Referring to FIG. 27, CPU 110 determines whether or not it has received the instruction for selecting a pen from the user via touch panel 102 (step S502). When having received the instruction for selecting a pen from the user (YES in step S502), CPU 110 changes the pen ID (step S504). CPU 110 repeats the process from step S502.

When having not received the instruction for selecting a pen from the user (NO in step S502), CPU 110 determines whether or not it has received the handwriting instruction (stroke operation) from the user via touch panel 102 (step S506). When having received the handwriting instruction (stroke operation) from the user (YES in step S506), CPU 110 performs an input process (step S300). Note that the input process (step S300) is as described above.

When having not received the handwriting instruction (stroke operation) from the user (NO in step S506), CPU 110 determines whether or not it has received the drawing data from chat server 400 (step S508). When having received the drawing data from chat server 400 (YES in step S508), CPU 110 performs a server reception process (step S600). The server reception process (step S600) will be described later. CPU 110 repeats the process from step S502.

When having not received the drawing data from chat server 400 (NO in step S508), CPU 110 determines whether or not it has received the drawing data from another mobile phone (step S510). When having received the drawing data from another mobile phone (YES in step S510), CPU 110 performs a terminal reception process (step S700). The terminal reception process (step S700) will be described later. CPU 110 repeats the process from step S502.

CPU 110 repeats the process from step S502 also when it has not received the drawing data from another mobile phone (NO in step S510).

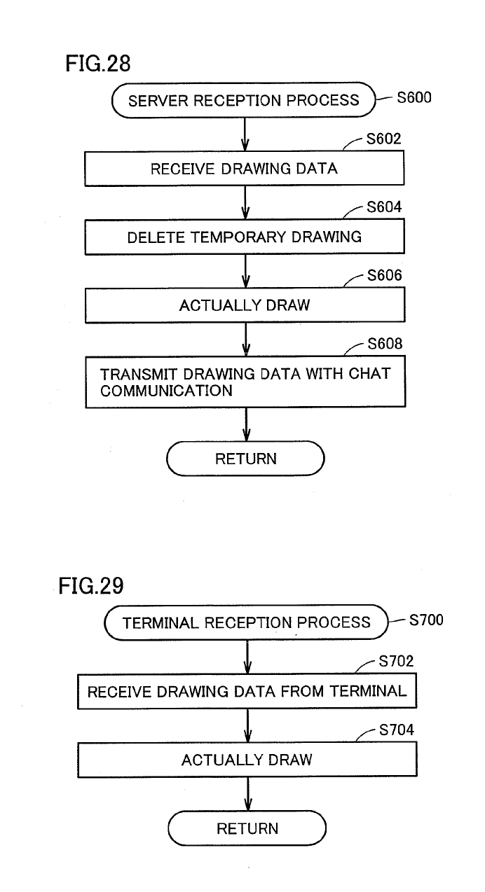

Then, the server reception process in this modification will be described. FIG. 28 is a flowchart illustrating a procedure of the server reception process in mobile phone 100 according to the present modification.

Referring to FIG. 28, CPU 110 receives the drawing data from chat server 400 via communication interface 101 (step S602). CPU 110 causes the handwriting image temporarily drawn on touch panel 102 to be deleted (step S604).

CPU 110 causes the handwriting image to be drawn on touch panel 102 based on the drawing data (step S606). CPU 110 transmits the drawing data via communication interface 101 to another mobile phone under chat communication. CPU 110 returns to the handwriting chat process.

Then, the terminal reception process in the present modification will be described. FIG. 29 is a flowchart illustrating a procedure of the terminal reception process in mobile phone 100 according to the present modification.

Referring to FIG. 29, CPU 110 receives drawing data from another mobile phone under communication via communication interface 101 (step S702). CPU 110 causes a handwriting image to be drawn on touch panel 102 based on the drawing data (step S704). CPU 110 returns to the handwriting chat process.

<Comparison with Another Network System>

Network system 1 according to the present embodiment (including a modification thereof) will be hereinafter compared with another network system. Another network system will be first described.

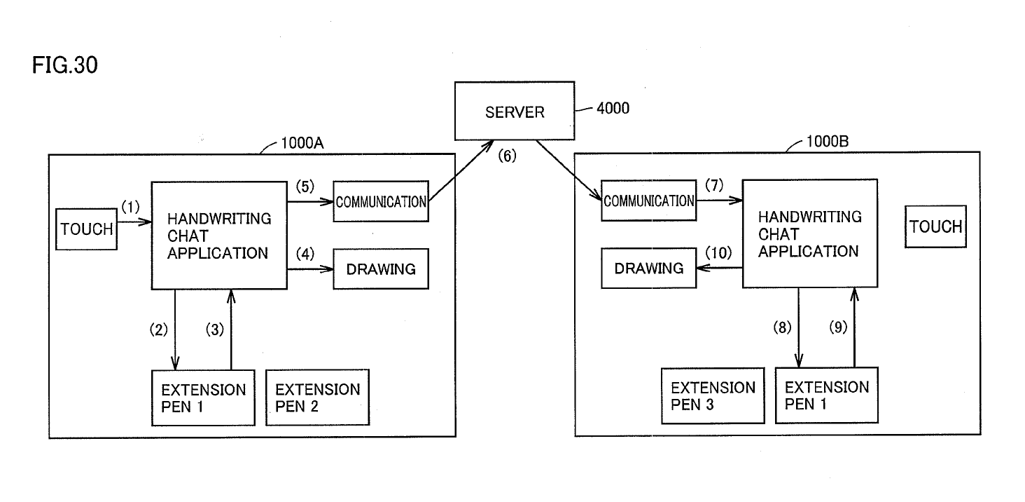

FIG. 30 is an entire block diagram of another server-client type network system. Referring to FIG. 30, in another server-client type network system, the server merely transfers the input information from one mobile phone to another mobile phone.

More specifically, in another server-client type network system, the user inputs the handwriting instruction and the pen type into a first mobile phone 1000A via a touch panel (1). The handwriting chat application of first mobile phone 1000A generates drawing data from the handwriting instruction and the pen type based on the data (extension pen data) used for converting the stroke information into drawing data in accordance with the pen type (2), (3).

The handwriting chat application of first mobile phone 1000A causes the display to display the handwriting image based on the drawing data (4). The handwriting chat application of first mobile phone 1000A transmits the handwriting instruction and the pen type to server 4000 (5), (6).

Server 4000 transmits the handwriting instruction and the pen type to a second mobile phone 1000B (6), (7). The handwriting chat application of second mobile phone 1000B generates drawing data from the handwriting instruction and the pen type based on the data (extension pen data) used for converting the stroke information into drawing data in accordance with the pen type (8), (9). The handwriting chat application of second mobile phone 1000B causes the display to display the handwriting image based on the drawing data (10).

In other words, another server-client type network system requires that each of mobile phones includes data (extension pen data) for converting the stroke information into drawing data in accordance with the pen type.

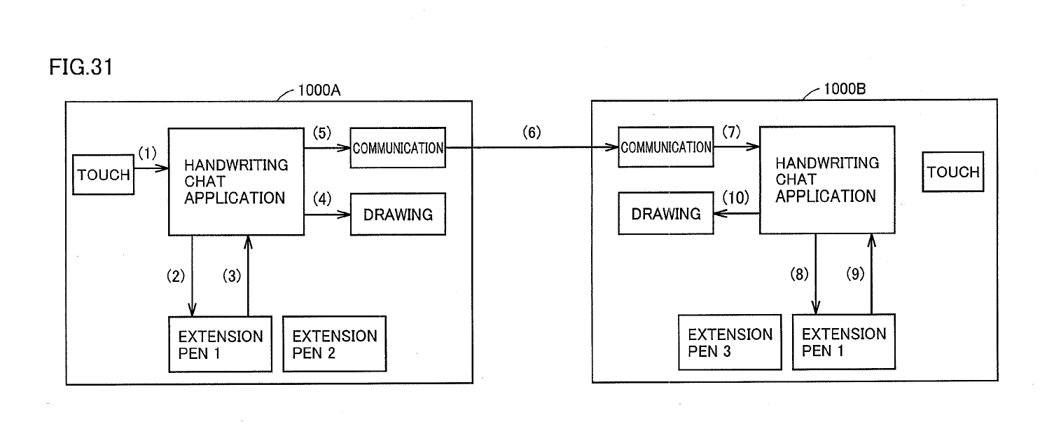

FIG. 31 is an entire block diagram of another P2P-type network system. Referring to FIG. 31, in another P2P-type network system, the input information received by one mobile phone is merely transmitted to another mobile phone.

More specifically, in another server-client type network system, the user inputs a handwriting instruction and a pen type into first mobile phone 1000A via the touch panel (1). The handwriting chat application of first mobile phone 1000A generates drawing data from the handwriting instruction and the pen type based on the data (extension pen data) for converting the stroke information into drawing data in accordance with the pen type (2), (3). The handwriting chat application of first mobile phone 1000A causes the display to display the handwriting image based on the drawing data (4).

The handwriting chat application of first mobile phone 1000A transmits the handwriting instruction and the pen type to second mobile phone 1000B (5), (6), (7). The handwriting chat application of second mobile phone 1000B generates drawing data from the handwriting instruction and the pen type based on the data (extension pen data) for converting the stroke information into drawing data in accordance with the pen type (8), (9). The handwriting chat application of second mobile phone 1000B causes the display to display the handwriting image based on the drawing data (10).

In other words, another P2P-type network system also requires that each of mobile phones includes data (extension pen data) used for converting the stroke information into drawing data in accordance with the pen type.

Thus, another network system requires that each of mobile phones includes data used for converting the stroke information into drawing data in accordance with the pen type. In contrast, in network system 1 according to the present embodiment (including a modification thereof), as shown in FIGS. 25 and 26, chat server 400 converts the stroke information into drawing data in accordance with the pen type, which eliminates the need for each of mobile phones to include data (extension pen data) for converting the stroke information into drawing data in accordance with the pen type. Furthermore, companies operating chat server 400 can optionally add and update the pen type (extension pen data).

<Application Example of Network System 1 according to Present Embodiment>

It is needless to say that the present invention is also applicable to a case achieved by providing a system or a device with a program. The present invention's effect can also be achieved in such a manner that a storage medium having stored therein a program represented by software for achieving the present invention is provided to a system or a device, and a computer (or CPU or MPU) of the system or device reads and performs a program code stored in the storage medium.

In that case, the program code per se read from the storage medium will implement the function of the above-described embodiment, and the storage medium having the program code stored therein will configure the present invention.

The storage medium for providing the program code can, for example, be a hard disc, an optical disc, a magneto-optical disc, a CD-ROM, a CD-R, a magnetic tape, a non-volatile memory card (an IC memory card), ROMs (mask ROM, flash EEPROM, or the like), or the like.

Furthermore, it is needless to say that not only can the program code read by the computer be executed to implement the function of the above-described embodiment, but a case is also included in which, in accordance with the program code's instruction, an operating system (OS) running on the computer performs an actual process partially or entirely and that process implements the function of the above-described embodiment.

Furthermore, it is also needless to say that a case is also included in which the program code read from the storage medium is written to memory included in a feature expansion board inserted in a computer or a feature expansion unit connected to the computer, and subsequently, in accordance with the program code's instruction, a CPU included in the feature expansion board or the feature expansion unit performs an actual process partially or entirely and that process implements the function of the above-described embodiment.

It should be understood that the embodiments disclosed herein are illustrative and non-restrictive in every respect. The scope of the present invention is defined by the terms of the claims, rather than the description above, and is intended to include any modifications within the scope and meaning equivalent to the terms of the claims.

### REFERENCE SIGNS LIST

1 network system,
100, 100A, 100B, 100C mobile phone,
101 communication interface,
101A, 101B, 101C input data,
102 touch panel,
103 memory,
104 pen tablet,
106 button,
107 display,
108 microphone,
109 speaker,
110 CPU,
111 first notification unit,
112 second notification unit,
120 stylus pen,
300 personal computer,
400 chat server,
405 CPU,
406 memory,
407 fixed disk,
408 internal bus ,
409 server communication interface,
409A, 409B, 409C drawing data,
500 Internet network,
700 carrier network.

1. A network system comprising a first terminal and a server, said first terminal including:
a first communication interface;
a touch panel for receiving a handwriting instruction and a pen type; and
a first processor for transmitting said handwriting instruction and said pen type to said server via said first communication interface and causing said touch panel to display a handwriting image corresponding to said pen type based on drawing data from said server, and
said server including:
a server communication interface;
a memory associating a rule for conversion from said handwriting instruction into said drawing data with said pen type and storing the rule and the pen type; and
a server processor referring to said memory for converting said handwriting instruction from said first terminal into said drawing data used for displaying said handwriting image corresponding to said pen type from said first terminal and transmitting said drawing data to said first terminal via said server communication interface.

2. The network system according to claim 1, further comprising a second terminal, wherein
said server processor transmits said drawing data also to said second terminal via said server communication interface, and
said second terminal includes:
a display;
a second communication interface; and
a second processor for causing said display to display the handwriting image corresponding to said pen type based on said drawing data from said server.

3. The network system according to claim 1, further comprising a second terminal, wherein
said first processor transmits said drawing data to said second terminal via said first communication interface, and
said second terminal includes:
a display;
a second communication interface; and
a second processor for causing said display to display the handwriting image corresponding to said pen type based on said drawing data from said first terminal.

4. The network system according to claim 1, wherein
said server processor transmits pen data showing a plurality of pen types adapted for said server to said first terminal via said server communication interface, and
said first processor causes said touch panel to display said plurality of pen types in a selectable manner based on said pen data.

5. The network system according to claim 1, wherein said first processor causes said touch panel to display a handwriting image corresponding to a prescribed pen type from a time when said handwriting instruction is received until a time when said handwriting image corresponding to said pen type is displayed.

6. A communication method in a network system including a first terminal and a server,
said server including a memory for associating a rule for conversion from a handwriting instruction into drawing data with a pen type and storing the rule and the pen type,
said communication method comprising the steps of:
said first terminal receiving the handwriting instruction and the pen type;
said first terminal transmitting said handwriting instruction and said pen type to said server;
said server referring to said memory for converting said handwriting instruction from said first terminal into said drawing data used for displaying a handwriting image corresponding to said pen type from said first terminal;
said server transmitting said drawing data to said first terminal; and
said first terminal displaying the handwriting image corresponding to said pen type based on said drawing data from said server.

7. The communication method according to claim 6, said network system further including a second terminal,
said communication method further comprising the steps of:
said server transmitting said drawing data to said second terminal; and
said second terminal causing a display to display the handwriting image corresponding to said pen type based on said drawing data from said server.

8. The communication method according to claim 6, said network system further including a second terminal,
said communication method further comprising the steps of:
said first terminal transmitting said drawing data to said second terminal; and
said second terminal causing a display to display the handwriting image corresponding to said pen type based on said drawing data from said first terminal.

9. The communication method according to claim 6, further comprising the steps of:
said server transmitting pen data showing a plurality of pen types adapted for said server to said first terminal; and,
said first terminal displaying said plurality of pen types in a selectable manner based on said pen data.

10. The communication method according to claim 6, further comprising the step of:
said first terminal displaying a handwriting image corresponding to a prescribed pen type from a time when said handwriting instruction is received until a time when said handwriting image corresponding to said pen type is displayed.
